(19) United States
(12) Patent Application Publication
(10) Pub. No.: US 2006/0175918 A1
(43) Pub. Date: Aug. 10, 2006

(54) Combined high power oil filled submersible motor and its protector

(76) Inventors: Chaorong Zhuang, Tianjin (CN); Zongmin Li, Tianjin (CN); Shudong Dong, Tianjin (CN)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/194,209

(22) Filed: Aug. 1, 2005

(30) Foreign Application Priority Data
Feb. 6, 2005 (CN) 200520025275.7

(51) Int. Cl. H02K 5/16; H02K 7/08

(52) U.S. Cl. 310/90

(57) ABSTRACT

The present utility model relates to submersible motor and its protector. A shared assembling base is provided to support and fix the end of housing of submersible motor and protector The end of the assembling base connecting with the protector has a thrust bearing to support the motor shaft and form a thrust bearing chamber with the seal base of the protector, the shared assembling base has a cooling oil connecting passage, a coupling for connecting motor main shaft with the transmission shaft of the protector is located in the thrust bearing chamber, the isolation chamber where the bag is put in is formed between the seal base and assembly head base of the protector, a mechanical seal outside the assembly head base is provided for acting on the main shaft. This structure makes the different component parts simplified reasonably, comparing with the separate structure, the submersible motor part omits the thrust bearing, the protector part omits the center support base and the mechanical seal of its side, which makes this combined protector become two chambers structure and makes the total length of the protector shortened obviously so as to be convenient for transportation and downhole operating.

This application claims priority of Chinese Application No. 200520025275.7, filed Feb. 6, 2005. The content of which is hereby incorporated in its entirety by reference into this application.

### THE TECHNICAL FIELD

The present utility model relates to the submersible motor, especially relates to a high temperature and pressure resistance combined high power oil filled submersible motor and its protector.

### BACKGROUND ART

The existing high power submersible motor and protector with power range 6.2 KW-24.5 KW which conforms to the National Standard of GB/T16750.1˜16750.3-1997 is designed with separate structure to be convenient for machining and transportation due to the complicated structure and overlength of the protector and the motor shaft and protector shaft are connected by a coupling while being used. The protector and submersible motor with separate structure also make the different component structure complicated, that is, the submersible motor must have a assembly head base next to the protector, a thrust bearing must be set outside of assembly head base to support the shaft and release the axial force; The protector must have an assembly base next to the motor and a seal seat and a center support seat must be set between the assembly head base and assembly base, a thrust bearing must be set on the center support seat to support the transmission shaft and release the axial force, and a mechanical seal which resists sand, impurity and well fluid must independently be set outside of the assembly base and side of the center support seat. As a result of the above the protector is divided into three chambers by the different functional bases. The installation and downhole operating has some difficulty after the transmission shaft of the above protector with complicated structure connects with the main shaft of motor.

Inventive Content

The present utility model relates to high power oil filled submersible motor and its protector with easy installation and operating, which is designed for resolving the technology problem that it's difficult for the above said submersible motor and protector with separate structure to install and operate.

The present utility model uses the following technology: one end of the shared assembling base supports and fixes the motor housing and another end supports and fixes the protector housing, the end of the assembling base connecting with the protector has a thrust bearing to support the motor shaft, a thrust bearing chamber is formed between the shared assembling base and the seal base of protector, the shared assembling base has a connecting passage for cooling oil to connect the inner chamber of the motor with the chamber of the thrust bearing of the protector. A coupling is located in the thrust bearing chamber for connecting the motor main shaft and the transmission shaft of the protector, the isolation chamber where the bag is put in is formed between the seal base and assembly head base of the protector, a mechanical seal is provided outside the assembly head base for acting on the transmission shaft.

The present utility model also may use the following technical measures:

The housing of the said protector is consisted of the bottom housing which is supported and fixed by the shared assembling base and seal base and the upper housing which is supported and fixed by seal base and assembly head base, the upper housing and bottom housing are connected with the related base by thread.

The said shared assembling base is connected with one end of the motor housing by a thread.

The technical effect and advantages of this utility model are: This structure makes the different component parts simplified reasonably, comparing with the separate structure, the submersible motor part omits the thrust bearing, the protector part omits the center support base and the mechanical seal of its side, which makes this combined protector become two chambers structure and make the total length of the protector shortened obviously. The shared assembling base of this combined structure replaces the submersible motor assembly head base and protector assembly base of the separate structure so that the submersible motor and protector become a integrative body by rigid connecting, it's very convenient for transportation and downhole installation and operating. Testing shows that not only every technical criteria of this combined structure conforms to the national standard of GB/T16750.1˜16750.3-1997 but also the total length is shortened obviously, taking the product with 60 HZ, 10 HP as example, the total length of this combined structure is only 1714.5 mm and which is 1333.61 mm shorter than the total length of former separate structure with the length of 3048.11 mm. This utility model has the obvious advantage of simple structure, small body, low cost and easy transportation and operating.

### THE DESCRIPTION OF THE DRAWINGS

FIG. 1 shows the structural sectional view of the shared assembling base connecting with submersible motor;

FIG. 2 shows structural sectional view of the shared assembling base connecting with protector.

The reference numerals in the drawings:

1. submersible motor housing 2. motor main shaft 3. shared assembling base 4. cooling oil connecting passage 5. thrust bearing 6. bottom housing; 7. thrust bearing chamber 8. seal seat; 9 upper housing; 10. bag 11. Isolation chamber 12. assembly head base 13. mechanical seal 14. shipping cap; 15 transmission shaft; 16 coupling.

### THE PREFERRED EMBODIMENT

The following is to further explain this utility model by referencing the embodiments and the Figs:

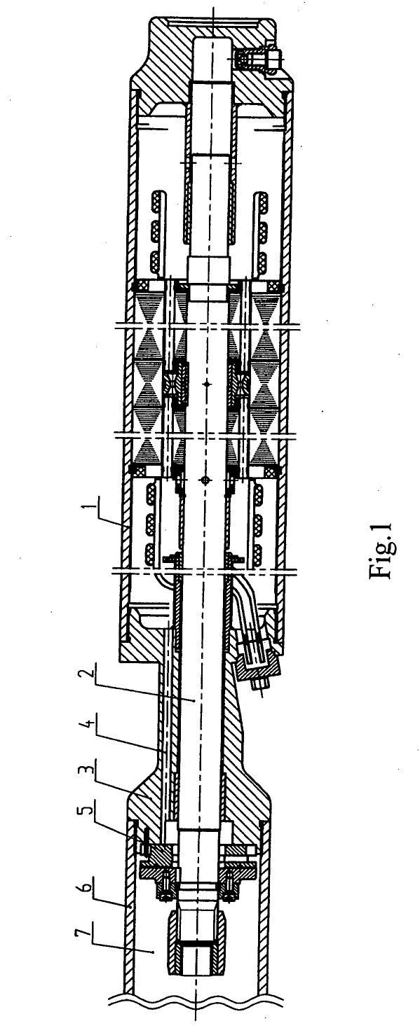

As shown in the FIG. 1, the right end of shared assembling base 3 supports and is fixed by the thread to the one end of the submersible motor housing 1, The shared assembling base 3 is provided with a cooling oil connecting passage 4 which connects the motor inner chamber and protector inner chamber.

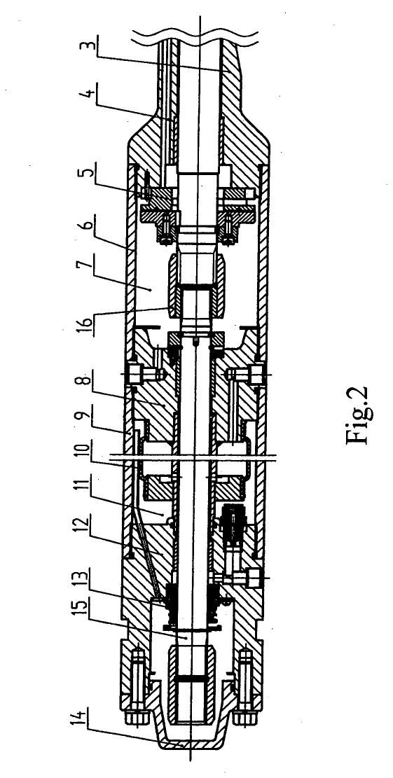

As shown in FIG. 2, the protector housing is consisted of the upper housing 9 and bottom housing 6, which is determined according to the use state of the present combined device, in which the assembling head base 12 and the seal base 8 support and fix the upper housing 9 by thread, the seal base 8 and the shared assembling base 3 support and fix the bottom housing 6 by thread. The end connecting the protector of shared assembling base 3 is provided with a thrust bearing 5 to support the main shaft of motor 2, the thrust bearing chamber 7 is formed between shared assembling base 3 and seal seat 8 of the protector. The protector inner chamber which connects the cooling oil connecting passage 4 is the thrust bearing chamber. The coupling 16 connecting the motor main shaft 2 and the transmission shaft 15 of the protector is located in the thrust bearing chamber 7. The bag 10 is set in the isolation chamber 11 which is formed between the seal seat 8 of protector and assembly head base 12. A mechanical seal 13 is provided outside the protector assembly head base 12 for acting on the motor main shaft 2. Referencing the FIG. 2, a bolt on shipping cap 14 is set outside the assembly head base 12 to protect the transmission shaft 15.

1. The combined high power oil filled submersible motor and its protector, comprising a submersible motor, a protector and a shared assembling base, which is characterized that one end of the shared assembling base supports and fixes the motor housing and another end supports and fixes the protector housing, the end of the assembling base connecting with the protector has a thrust bearing, a thrust bearing chamber is formed between the shared assembling base and the seal base of the protector, the shared assembling base has a cooling oil connecting passage connecting the inner chamber of the motor to the thrust bearing chamber of the protector, a coupling for connecting motor main shaft with the transmission shaft of the protector is located in the thrust bearing chamber, the isolation chamber where the bag is put in is formed between the seal base and assembly head base of the protector, a mechanical seal is provided outside the assembly head base for acting on the transmission shaft.

2. The combined high power oil filled submersible motor and its protector according to the claim 1, wherein the housing of the said protector is consisted of the bottom housing which is supported and fixed by the shared assembling base and seal base and the upper housing which is supported and fixed by seal base and assembly head base, the upper housing and bottom housing are connected with the related base by thread.

3. The combined high power oil filled submersible motor and its protector according to the claim 1, wherein the said shared assembling base is connected with one end of the motor housing by a thread.
